(19) United States
(12) Patent Application Publication
(10) Pub. No.: US 2017/0201382 A1
(43) Pub. Date: Jul. 13, 2017

(54) Secure Endpoint Devices

(71) Applicant: Ty Lindteigen, Chandler, AZ (US)

(72) Inventor: Ty Lindteigen, Chandler, AZ (US)

(21) Appl. No.: 15/422,451

(22) Filed: Feb. 1, 2017

Related U.S. Application Data
(63) Continuation-in-part of application No. 13/855,713, filed on Apr. 3, 2013.
Application No. 13/855,713 is a continuation-in-part of application No. 14/623,497, filed on Feb. 16, 2015, now abandoned.
Application No. 14/623,497 is a continuation-in-part of application No. 14/799,569, filed on Jul. 14, 2015.
Application No. 14/799,569 is a continuation-in-part of application No. 15/193,026, filed on Jun. 25, 2016.
Application No. 15/193,026 is a continuation-in-part of application No. 14/952,907, filed on Nov. 25, 2015.
Application No. 14/952,907 is a continuation-in-part of application No. 15/385,843, filed on Dec. 20, 2016.

(51) Int. Cl. H04L 9/32; H04L 29/06

(52) U.S. Cl. CPC H04L 9/3263; H04L 63/0876; H04L 63/0428; H04L 9/3247; H04L 63/0281

(57) ABSTRACT

The application illustrates methods, apparatuses, and systems for securely transmitting data between a first endpoint device and a second endpoint device comprising the first endpoint device, a first security gateway, a first network infrastructure, a secure network with the secure network enabled to establish a secure communication link directly between the first security gateway and the second security gateway enabling the first endpoint device to transmit data directly to the second endpoint device via the secure communication link.

### CROSS-REFERENCE TO RELATED APPLICATIONS

The present application is a continuation-in-part, claims priority, and incorporates herein by reference to Ser. No. 15/385,843 filed Dec. 20, 2016; Ser. No. 13/855,713 filed Apr. 3, 2013; Ser. No. 14/623,497 filed Feb. 16, 2015; Ser. No. 14/799,569 filed Jul. 14, 2015; Ser. No. 15/193026 filed Jun. 25, 2016; and Ser. No. 14/952,907 filed Dec. 14, 2015.

### BACKGROUND

This invention relates generally to the field of securing, sending, receiving, and storing data via a network.

Computing devices (e.g. endpoint devices) generate a significant amount of data. Several remote computing devices generating various types of data need to securely communicate and share such various types of data among multiple computing devices over a communications network. There is a need for such remote computing devices to securely share said various types of data amongst the multiple computing devices, sometimes simultaneously.

The invention disclosed in this application provides novel methods, apparatuses, and systems for securing, sending, receiving, and storing data between endpoint devices via a network.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram illustrating a methods, apparatuses, and systems for securing, sending, receiving, and storing data via a network in accordance with the teachings of the present invention; and

FIG. 2 is a diagram illustrating a methods, apparatuses, and systems for securing, sending, receiving, and storing data via a network using a file-sharing system with the teachings of the present invention; and

FIG. 3 is a diagram illustrating a computing device in accordance with the teachings of the present invention.

### SUMMARY

The invention provides novel methods, apparatuses, and systems for securing, sending, receiving, and storing data between endpoint devices via a network. First a 1100 first endpoint device may be coupled to a 4000 secure network. Next, a 2100 second endpoint device may be coupled to the 4000 secure network. Next, the 4000 secure network is enabled to establish a secure communication tunnel directly between the 1100 first endpoint device and the 2100 second endpoint device enabling the 1100 first endpoint device to transmit and receive data directly to the 2100 second endpoint device via the secure communication tunnel. Further the 4000 secure network may include a continuum server; a 4001 management server; a 4002 database; a 4003 relay server; and a 4004 message server.

The continuum server may further be enabled to: manage the authentication of the 1100 first endpoint device and the 2100 second endpoint device; coordinate a capability of communication of messages between the 1100 first endpoint device and the 2100 second endpoint device and with the 4001 management server; and establish a capability of streaming data sessions between 1100 first endpoint device and the 2100 second endpoint device. In addition, the 4001 management server may add the 1100 first endpoint device to an endpoint device list wherein the endpoint device list includes an identity of the 1100 first endpoint device, a first certificate assigned to the 1100 first endpoint device, and a name for the 1100 first endpoint device. The 4001 management server may add the 2100 second endpoint device to the endpoint device list wherein the endpoint device list includes an identity of the 2100 second endpoint device, a second certificate assigned to the 2100 second endpoint device, and a name for the 2100 second endpoint device. The 4001 management server may assign the 1100 first endpoint device and the 2100 second endpoint device to a first security group. The 4001 management server may further introduce the 1100 first endpoint device to the 2100 second endpoint device by providing a first signed and encrypted message containing the 1100 first endpoint device with a name and a public certificate of the 2100 second endpoint device, and a second signed and encrypted message containing the 2100 second endpoint device with a name and a public certificate of the 1100 first endpoint device, along with providing both the first device and the second device the identity of a security group that both the first device and the second device are members.

The data communicated between the 1100 first endpoint device and the 2100 second endpoint device may be encrypted. The 1100 first endpoint device is enabled to decrypt any encrypted data sent by the 2100 second endpoint device using the certificate of the 2100 second endpoint device. The 4002 database may be enabled to store a public certificate of the 1100 first endpoint device and the 2100 second endpoint device so that the 4000 secure network can access the public certificates of the 1100 first endpoint device and the 2100 second endpoint device to authenticate each endpoint device for secure communication directly between the 1100 first endpoint device and the 2100 second endpoint device. The packet 4003 relay server may be enabled to act as a rendezvous point for streaming data sessions between the 1100 first endpoint device and the 2100 second endpoint device.

Such methods for securing, sending, receiving, and storing data between endpoint devices via a network may include coupling a 1100 first endpoint device to a 4000 secure network; coupling a 2100 second endpoint device to the 4000 secure network; the 4000 secure network comprising at least one continuum server; at least one 4001 management server further comprising a certificate manager and a deployment manager; at least one 4002 database; at least one 4003 relay server; and at least one 4004 message server; and establishing a secure communication tunnel by the 4000 secure network directly between the 1100 first endpoint device and the 2100 second endpoint device enabling the 1100 first endpoint device to transmit data directly to the 2100 second endpoint device via the secure communication tunnel. The certificate manager may execute the following management functions: certificate life cycle, secure group life cycle, and provisioning token life cycle. The deployment manager may add and remove certificates, keeps track of billing per use or access to the 4000 secure network, knowing the physical entity behind the certificate if applicable to an application or use scenario, identity proxies for mapping the certificate to another credential. The certificate manager and deployment manager may be deployed using the 4000 secure network enabling each endpoint device to have an isolated root of trust from other certificate managers and other deployment managers. Further, the certificate manager and deployment manager may be set up as endpoint devices to the 4000 secure network. The 4001 management server may also performs at least one of the following: organizing the 1100 first endpoint device and 2100 second endpoint device into an endpoint device list; setting up a security group including the 1100 first endpoint device and the 2100 second endpoint device; securely introducing the 1100 first endpoint device assigned to the security group to the 2100 second endpoint device assigned to the security group by providing the 1100 first endpoint device with a public certificate of the 2100 second endpoint device and 2100 second endpoint device with the public certificate of the 1100 first endpoint device; securely removing the 1100 first endpoint device from the security group including removing the public certificate for the 2100 second endpoint device from the 1100 first endpoint device.

Such methods for securing, sending, receiving, and storing data between endpoint devices via a network may also include a 4000 secure network acting as a proof-of-possession certificate challenge for a 1100 first endpoint device and a 2100 second endpoint device connected to the 4000 secure network via a secure communication tunnel before allowing the 1100 first endpoint device to connect to the 2100 second endpoint device. Further the 4000 secure network may transfer an authenticated identity between the 1100 first endpoint device and the 2100 second endpoint device enabling the 1100 first endpoint device and the 2100 second endpoint device to know the identity of the other endpoint devices. The secure server may also authenticate a set of data traffic from the 1100 first endpoint device before delivering the set of data traffic to the 2100 second endpoint device, wherein the 4000 secure network authenticates and delivers the set of data traffic without breaking an end-to-end confidentiality between the 1100 first endpoint device and the 2100 second endpoint device. The 4000 secure network may authenticate each the 1100 first endpoint device and the 2100 second endpoint device to sit behind an inbound-blocked firewall such that the 1100 first endpoint device and the 2100 second endpoint device are not directly accessible through a network. Further an IP address of the 1100 first endpoint device of the 4000 secure network may be changed such that the the secure communication tunnel through the 4000 secure network may migrate to a new IP address such that any data traffic to or from the first IP address is sent between the 1100 first endpoint device and the 2100 second endpoint device. Further, if the first IP address of the 4000 secure network is changed, the secure communication tunnel through the 4000 secure network may transition automatically to a new first IP address such that the 1100 first endpoint device and 2100 second endpoint device connected to the first IP address may be connected at the new IP address, with no data loss between the first endpoint and the 2100 second endpoint device.

### DETAILED DESCRIPTION OF THE DRAWINGS

Although the following descriptions will proceed with reference being made to illustrative embodiments, many alternatives, modifications, and variations thereof will be apparent to those skilled in the art. Accordingly, it is intended that the claimed subject matter be viewed broadly. Examples are provided as reference and should not be construed as limiting. The term “such as” when used should be interpreted as “such as, but not limited to.”

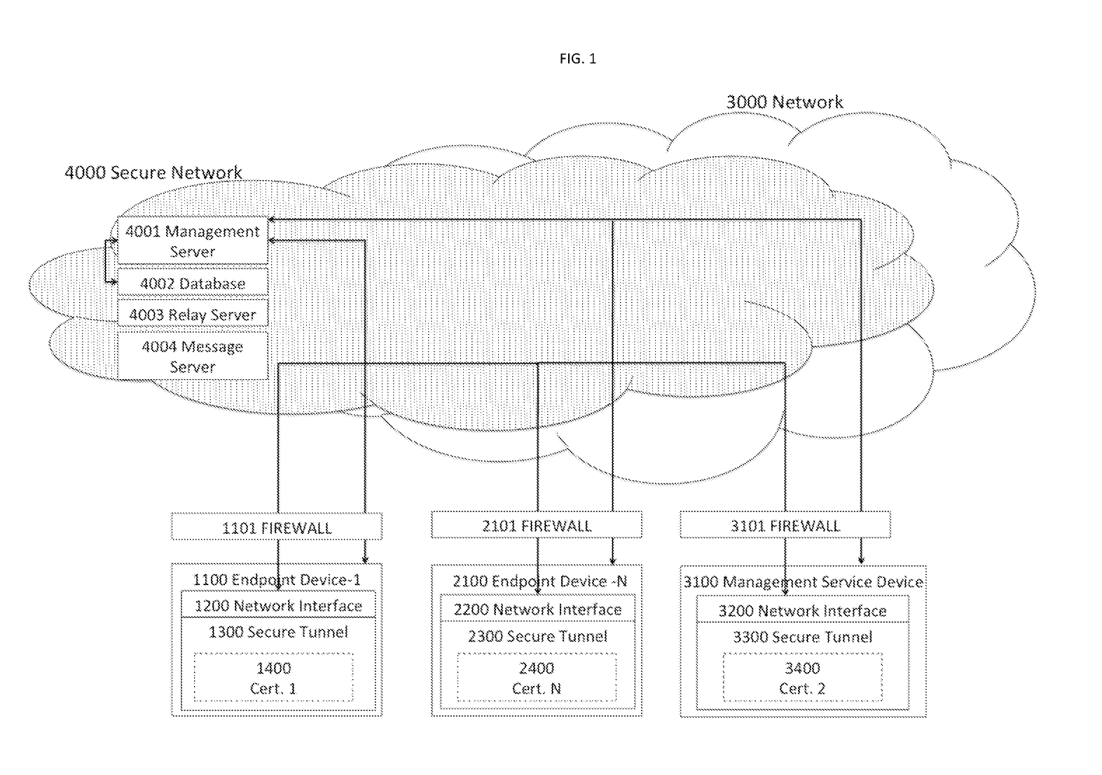

FIG. 1 illustrates methods, apparatuses, and systems for securely transmitting various types of data amongst the multiple remote endpoint devices. At least one endpoint device is coupled to a 4000 secure network. At least one other endpoint device also coupled to the 4000 secure network. The 4000 secure network is enabled to establish a secure communication link with each of the endpoint devices, as described in further detail herein. The 1100 first endpoint device and the 2100 second endpoint device may each be enabled to block unauthorized access from the network while permitting outward communication to the network. The 1100 first endpoint device and the 2100 second endpoint device may also be enabled to establish multiple secure tunnels with multiple network interfaces to establish multiple communication links between the endpoint devices via the network infrastructure.

The 4000 secure network ensures secure routing by authenticating the 1100 first endpoint device and the 2100 second endpoint device and transporting encrypted data between the 1100 first endpoint device and the 2100 second endpoint device. The 4000 secure network may include infrastructure; for example highly distributed, cloud-based network components that may include dedicated hardware as well as software applications running in data centers throughout the world. Data traveling between the 1100 first endpoint device and the 2100 second endpoint device via the 4000 secure network may be in encrypted form. The infrastructure of the 4000 secure network may not have any mechanism for accessing the data or encryption keys, much less decrypting the encrypted data being routed between the security gateways.

The 4000 secure network includes the following elements: at least one 4001 management server; at least one 4002 database; at least one 4003 relay server; and at least one 4004 message server. The 4001 management server is enabled to manage the authentication of multiple endpoint devices. The 4001 management server may also be enabled to coordinate the communication of messages between the endpoint devices and with the 3100 management service device. The 4001 management server may also be enabled to establish streaming data sessions between the endpoint devices. The 4002 database may be enabled to store the public certificates of the endpoint devices such that the 4001 management server can access the authentication certificates of the endpoint devices to authentic the endpoint devices for secure communication directly with each other. The packet 4003 relay server may be enabled to act as a rendezvous point for streaming data sessions between the endpoint devices. The messaging server may be enabled to temporarily store and transit messages amongst the 4001 management server and the endpoint devices.

Physical Deployment of the Endpoint Devices

Each endpoint device either is shipped with or downloads an application enabled to set up the 4000 secure network from an appropriate distribution channel. During the installation process, the endpoint device generates its own unique cryptographic key-pair, for example a public key and private key, along with a certificate signing request (“CSR”) based on the public key and a list of capabilities, for example encryption strength, roles, and functionalities.

For example, the 1100 first endpoint device's public key can be used by a trusted 2100 second endpoint device to encrypt data intended for the 2100 second endpoint device, while the 1100 first endpoint device's private key is used to decrypt that encrypted data. Because only the private key can decrypt messages encrypted with the corresponding public key, it is stored securely on the device (e.g. using the Advanced Encryption Standard (“AES”) AES-256 Key Wrap algorithm) and never exposed. An appropriate entropy source may be used to seed the deterministic random bit generator (“DRBG”) with a sequence of random bytes used to generate the key-pair. An acceptable level of entropy ensures that the private key is sufficiently random and thus, difficult for a potential attacker to determine. To secure data at rest (“DAR”) on the endpoint device, the endpoint device may also generate a volume key. The volume key may initially be created by the DRBG and then encrypted by the AES-256 Key Wrap algorithm using the key wrap key, for example derived from a user's password. The volume key may encrypt DAR using the AES-256 encryption algorithm in ciphertext stealing (“XTS”) mode.

Provisioning the Endpoint Devices

Each endpoint device establishes an identity with the 4000 secure network during the provisioning process. Each endpoint device submits a newly generated CSR and capabilities list to the 4001 management server. This process can occur automatically or manually. For automated provisioning, a secure-network management application program interface (“API”) (e.g using an API key) can be used to submit the CSR to the 4001 management server, for example via a Hypertext Transfer Protocol Secure (“HTTPS”) connection. For manual provisioning, the CSR and capabilities string may be provided to a user of a endpoint device, allowing the user or a designated administrator to create a certificate in a 4000 secure network dashboard. The 4001 management server may validate the endpoint device by signing the endpoint device's public certificate, for example by using the Elliptic curve Diffie-Hellman (“ECDH”) key-agreement protocol—with the ECDSA digital signature algorithm with secure hash algorithm dash 384 (“SHA-384”) hash values—and the 4001 management server's private key, and the endpoint device may download the signed public certificate and initial configuration data (such as certificate revocation lists) from the 4001 management server. As known in the art, Elliptic curve Diffie-Hellman (ECDH) is an anonymous key agreement protocol that allows two parties, each having an elliptic curve public-private key pair, to establish a shared secret over an insecure channel.

The public certificate may be a cryptographic fingerprint that binds the endpoint device's identity with its public key. As the basic unit of identification and validation, the public certificate plays a central role in 4000 secure network. Each endpoint device may have multiple certificates.

Also as part of the provisioning process, each endpoint device may generate two zero-knowledge password reset (“ZKPR”) splits via exclusive disjunction (“XOR”) operation on a random number (e.g. created by the DRBG) with the key wrap key, for example derived from a user password. One split is stored on the endpoint device, while another is sent to the 4001 management server. The endpoint device encrypts the ZKPR split sent to the 4001 management server by creating a key, for example by using the ECDH key-agreement protocol and the 4001 management server's public key, and then using the key to seed AES-256 in Cipher Block Chaining (“CBC”) mode. The ZKPR split will enable an administrator to remotely allow the user to unlock the endpoint device, all without revealing the user's password.

Grouping the Endpoint Devices

Communication only occurs between peer endpoint devices within secure and externally anonymous groups. Secure contact groups are created, edited, and disbanded via the 4001 management server, either automatically/directly using the secure management API or manually by an administrator using a 4000 secure network dashboard. When the endpoint device is added to an existing secure contact group, the public certificates of other group members—along with routing information and endpoint device capabilities—are distributed to each of the endpoint devices, and the endpoint device's public certificate is distributed to the rest of the group. This pre-population of friendly names allows for connections between peers to be rapidly established. When changes to a group occur, the list of friendly public certificates is updated for each affected endpoint device.

Establishing Secure Presence

Presence is the act of a endpoint device registering its online status with the 4000 secure network. Presence enables the 4000 secure network to map a group of endpoint devices in real time without sharing or storing Internet protocol (“IP”) addresses, enabling the rapid establishment of connections. A 1100 first endpoint device may attempt to connect to the nearest (or first available) 4001 management server, for example via a temporary Transmission Control Protocol (“TCP”) socket. Before connecting to the 4000 secure network or another endpoint device, the 1100 first endpoint device and the 4001 management server authenticate each other using a challenge-response protocol, for example with a 32-byte device shared secret (“DSS”) generated on the 1100 first endpoint device using the DRBG, with each device proving that it has a valid public certificate signed by the 4001 management server and that it is in possession of the corresponding private key. A public-facing IP address is dynamically allocated to the endpoint device. Presence information is shared between 4001 management server via secure messaging and stored in the 4001 management server's memory.

The 1100 first endpoint device must maintain its presence connection by periodically updating its online status, for example via low-overhead User Datagram Protocol (“UDP”) messages containing the DSS and a counter value, with hash values created using the SHA-256 cryptographic hash function, with the 4001 management server at an interval specified by an application. By using the DSS, the 1100 first endpoint device may keep its connection to the 4001 management server alive without the need to unlock the private key. The use of counter values provides protection against spoofing. For applications that do not utilize secure sessions, it may be possible to register with the 4000 secure network without the need for establishing presence, by registering the DSS with a 4001 management server and receiving an updated 4001 management server list in return.

Secure Communication

Once the 1100 first endpoint device has registered with the 4000 secure network, it may share secure messages, for example text strings, raw sensor measurements, or status updates with peer endpoint devices. The 1100 first endpoint device may also share secure streaming sessions, for example voice calls, video calls, and video feeds with peer endpoint devices. The 1100 first endpoint device may share secure off-device storage with peer endpoint devices via public cloud (e.g. a cloud service provider) or private cloud (e.g. a enterprise network).

To send a secure message to another endpoint device within its secure contact group, the 1100 first endpoint device first encrypts the message by creating a key (e.g. using ECDH and the receiving endpoint device's public key) and then using the key to seed AES-256 in CBC mode; the encrypted message is given a unique hash value using SHA-256. The message is sent to the 4001 management server with which the 1100 first endpoint device has established a secure presence connection. If necessary, the 4001 management server may replicate the message to other 4001 management servers via the reliable messaging servers. It may also be necessary for the message to be temporarily stored until the receiving endpoint device starts a secure presence connection.

To receive a secure message from another endpoint device within its secure contact group, the 1100 first endpoint device must first subscribe to any messages that have been addressed to it. To do so, the 1100 first endpoint device and the 4001 management server with which the 1100 first endpoint device has a presence connection authenticate each other (e.g. using a challenge-response protocol and SHA-256 hash values). The 4001 management server then notifies the reliable messaging server, which adds the subscribing 1100 first endpoint device as a trusted peer. As with presence, the 1100 first endpoint device must maintain its subscription by periodically updating its online status (e.g. via messages containing the message subscription secret (“MSS”) and a counter value, with hash values created using SHA-256) with the 4001 management server at an interval specified by an application. Once subscribed, the message is published to the 1100 first endpoint device's queue in the reliable messaging server, which then delivers the message to the 1100 first endpoint device. The 1100 first endpoint device decrypts the message by recreating the key (e.g. by using ECDH and its private key).

To initiate a secure streaming session with another endpoint device within its secure contact group, the 1100 first endpoint device must first reserve a packet 4003 relay server. To do so, the 1100 first endpoint device and the 4001 management server with which the 1100 first endpoint device has a presence connection authenticate each other (e.g. using a challenge-response protocol and SHA-256 hash values). The 4001 management server then reserves the nearest or a first available packet 4003 relay server.

The 4001 management server encrypts the public-facing IP address of the packet 4003 relay server by creating a key (e.g. by using the first security gateway's DSS) and then using the key to seed AES-256 in CBC mode. The 4001 management server then sends the encrypted IP address to the 1100 first endpoint device, which decrypts the IP address by recreating the key (e.g. using its DSS). Once the packet 4003 relay server is reserved, the 1100 first endpoint device re-encrypts the IP address for the accepting endpoint device and then sends the encrypted IP address to the accepting endpoint device via the 4001 management server. Through the packet 4003 relay server, the 1100 first endpoint device and the accepting endpoint device authenticate each other and exchange ECDH ephemeral keys before generating a unique ephemeral key for the session to seed AES-256.

During the streaming session, the 1100 first endpoint device and the accepting endpoint device continuously encrypt outgoing ciphertext blocks (e.g. TCP and/or UDP) and decrypts incoming ciphertext blocks, with the packet 4003 relay server transporting the packets. When one or both the 1100 first endpoint device and the accepting endpoint device cease the session, the packet 4003 relay server closes the tunnel.

In addition to one-to-one messaging and streaming, the 1100 first endpoint device can send messages to multiple endpoint devices and set up multi-peer streaming sessions. To enable group communication, the 1100 first endpoint device must first define the attributes for the group, including a group identification (“ID”), group name, list of member certificates, group owner, and group key. The 1100 first endpoint device encrypts the attributes for each group member by creating a key (e.g. by using ECDH and the receiving endpoint device public key) and then using the key to seed AES-256 (e.g. in CBC mode). Each encrypted set of attributes is sent to the appropriate endpoint device via a 4001 management server. The 1100 first endpoint device may then create a multi-destination welcome message for the group. This message is encrypted using the group key to seed AES-256 (e.g. in counter (“CTR”) mode. The message is placed into the queue (e.g. in the reliable messaging server) of every destination endpoint device.

Group messaging may be enabled by multi-destination messages. The message format is similar to that of one-to-one messaging, but also contains the group ID, the version of the group key, and a 32-bit cyclic redundancy check (“CRC”) checksum. The message is encrypted using the group key to seed AES-256 in CTR mode. The message is placed into the queue (in the reliable messaging server) of every destination endpoint device.

Group streaming may be enabled by the ability of packet 4003 relay servers to replicate sessions. Once the packet 4003 relay server is reserved, the 1100 first endpoint device re-encrypts the IP address (using the group key to seed AES-256 in CTR mode) as a multi-destination message. The message is placed into the queue (in the reliable messaging server) of every destination endpoint device. During the streaming session, the packet 4003 relay server replicates each packet to all of the other endpoint devices. The packet format is similar to that of one-to-one streaming, but also contains the version of the group key and the key use (e.g. messaging, video, voice, etc.).

Revocation of an Endpoint Device

There are several cases in which an endpoint device may need to be revoked from a secure contact group. For example, the endpoint device may reach the end of its lifecycle, or it may be reassigned or repurposed, or it may be lost or stolen. This process can occur via a designated administrator with the 4000 secure network dashboard, or it can occur via API calls by using a security network API directly. The 4001 management server may create a new certificate revocation list (“CRL”), which may be encrypted by creating a key (e.g. by using ECDH and the security gateway's public key) and then using the key to seed AES-256 in CBC mode. The CRL may be sent to by the 4001 management server, or the management serer may replicate the message to the other 4001 management servers via the reliable messaging servers. The 4001 management servers may distribute the updated CRL to the affected endpoint device within a secure contact group, including the revoked endpoint device. When the revoked endpoint device attempts to connect to the 4000 secure network, it will be blocked from communicating with other endpoint devices or performing other security network functions.

Establishing Secure Identity

Simply establishing a secure connection between the endpoint devices without knowing the identity of the other endpoint device may not be ideal. Common methods for secure connectivity (e.g. Transport Layer Security (“TLS”) and Internet Protocol Security (“IPSec”)) offer anonymous authentication (e.g. you know you are talking to the same endpoint device the entire time, but don't know the identity of the endpoint device), or only one-way authentication. For example, when a 1100 first endpoint device creates an HTTPS (HTTP over Transport Layer Security) session with a 2100 second endpoint device, the 1100 first endpoint device verifies it is communicating with the 2100 second endpoint device by identifying the 2100 second endpoint device's certificate, but the 2100 second endpoint device cannot verify the identity of the 1100 first endpoint device on the other side of the Transport Layer Security session. Instead, the 1100 first endpoint device must submit another credential (e.g. username or password) inside of the Transport Layer Security session, after the 1100 first endpoint device has created a secure tunnel with the 2100 second endpoint device. In this scenario, the identity problem can only be solved if the 2100 second endpoint device has a token for every endpoint device it communicates with so the 2100 second endpoint device and every other endpoint device can present their tokens and mutually authenticate each other. A preferable method is to introduce the 1100 first endpoint device and the 2100 second endpoint device (and any other number of end point devices) in advance of communication, and also remove them when communication between them is no longer desirable. In order to accomplish this, each endpoint device may need to be: provisioned (e.g associated with an identity that is useful to the system—a customer ID, verified name, email address, etc.), Shared (e.g. the verifiable identity and credential (e.g. certificate) needs to be shared with the other endpoint devices to be communicating with), Managed (e.g. continuously maintaining per application account settings, policies, location, and other information), Revoked (e.g. as endpoint devices, or accounts are transferred, lost, stolen, expired, or removed, then the trusted identity token (e.g. certificate) needs to also be updated or removed to reflect its status and eliminate potential harm to the remaining population of endpoint devices).

The 3100 management service device may include a certificate manager and a deployment manager. Where the certificate manager provides the following functions: certificate life cycle, secure group life cycle, and provisioning token life cycle management. The deployment manager is enabled to add and remove certificates, billing per use or access to the 4000 secure network, knowing the physical entity behind the certificate if applicable to an application or use scenario, identity proxies for mapping the certificate to another credential (e.g. a Windows Domain login credential or Lightweight Directory Access Protocol). The certificate manager and deployment manager may each be deployed for each application using the 4000 secure network. This enables each endpoint device to have an isolated “root of trust” from other certificate managers and deployment managers. Each certificate manager and deployment manager may also be an endpoint device to the 4000 secure network, allowing each to take advantage of the same security protections described herein. The invention enables a method for establishing secure identity without an outside third-party managing the certificate/token/identity of the endpoint devices. Each endpoint device is enabled to share its signed certificate with the other endpoint for every session. The 3100 management service device may include a user-friendly dashboard, e.g. a web-based, HTTPS-secured management portal. Using the dashboard, an administrator can view and manage the endpoint devices, the secure contact groups, the users, and roles with the certificate management enabled to take place automatically. If an endpoint device application requires a custom management interface or automated functionality, a custom interface can be built using an application program interface (API) that adheres to the representational state transfer (“REST”) standards, enabling developers to interact with the 3100 management service device using standard HTTPS methods.

Establishing a Trust Proxy

The 4000 secure network may also function as a trust proxy. The 4000 secure network may perform as a proof-of-possession certificate challenge for each endpoint device that connects to the 4000 secure network before allowing an endpoint device to connect to another endpoint device. The 4000 secure network sits in the middle. The 4000 secure network effectively transfers the authenticated identity between all endpoint devices within a communication session so each endpoint device within the communication session knows with whom they are communicating. The 4000 secure network effectively authenticates all data traffic before delivering the data traffic to the destination endpoint device. The 4000 secure network does this without breaking the end-to-end confidentiality between the endpoint devices. Authentication and confidentiality are handled separately, versus Transport Layer Security and IPSec that merges authentication and confidentiality together into a single layer; verifying identity necessarily means being able to decrypt the data as well. Without a trust proxy, computing devices are open to anonymous traffic that may be attempting to tamper with the server, e.g. walking through 4002 databases, fuzzing of interfaces looking for a vulnerability, determining what network services are available at what version to cross-reference against known vulnerabilities, brute-force attacks against username and password credentials, session hijacking, cross site scripting attacks, phishing, and over many other attack surfaces from touching the Internet.

This invention enables authenticated endpoint devices to sit behind all-inbound-blocked firewalls such that the endpoint devices are not directly accessible through the Internet. For example, if a firewall is bombarded by unauthenticated data packets, the firewall's IP address may be changed and the secure tunnels through the 4000 secure network will automatically migrate to the new IP address. The old IP address and its associate traffic may then be ignored by the endpoint devices. This invention also enables a method for securing a legacy device that cannot be updated to provide current security methods that remove the legacy device from direct access from an unauthenticated endpoint device (e.g. healthcare equipment on a hospital network with no access control or security put in place even though it provides life critical services to a patient, energy grid equipment that requires remote access but is too sensitive to use the 4G cellular coverage and instead must opt to run dedicated fiber or copper to each remotely operated substation, oil pump, or mining location).

In addition to the functions described above, the 4001 management server is also enabled to manage the endpoint devices, the certificates, and the security groups. The multiple endpoint devices may be organized within an endpoint device list. Each endpoint device list may include the certificate assigned to the endpoint device, and a name for the endpoint device. The 4001 management server is enabled to establish and manage any number of endpoint devices in the endpoint device list. The 4001 management server may also be enabled to set up and manage security groups. The 4001 management server may be enabled to assign endpoint devices to different security groups. The 4001 management server also introduces each endpoint device that has been assigned to a common security group to the other endpoint devices also assigned to the common security group. The 4001 management server may accomplish such introduction by providing each endpoint device assigned to a common security group with the public certificate of each other endpoint device assigned to the common security group. Each endpoint device would then be enabled to communicate directly with the other endpoint devices assigned to the same security group via the secure communicated established in the previous steps. Each endpoint device would be enabled to decrypt any encrypted data sent by another endpoint device using the public keys.

For example, when a 1100 first endpoint device is added to the network the 1100 first endpoint device would communicate the identifying information to the security server via the secured network connection. The security server would then add the 1100 first endpoint device to the endpoint device list and annotate at least the certificate assigned to the 1100 first endpoint device (e.g. Cert. 1), and a name for the 1100 first endpoint device (e.g. Name 1).

Next when a third endpoint device is added to the network, the third endpoint device would communicate the identifying information to the security server via the secured network connection. The security server would then add the third endpoint device to the endpoint device list and annotate at least the certificate assigned to the third endpoint device (e.g. Cert. 3) and a name for the third endpoint device (e.g. Name 3).

Next the security server may assign the 1100 first endpoint device and the third endpoint device to a first security group (e.g. Security Group 1). The 4001 management server also introduces the 1100 first endpoint device and the third endpoint device to each other by providing the 1100 first endpoint device with the public certificate and the third endpoint device with the public certificate. The 1100 first endpoint device and the third endpoint device are then enabled to communicate directly with the other endpoint device via the secure communication network established as previously disclosed herein. The 1100 first endpoint device and the third endpoint device are then enabled to decrypt any encrypted data sent by the other endpoint device using the public keys.

The 4001 management server may also be enabled to remove an endpoint device from a security group. The 4001 management server is enabled to remove the public certificates for the other endpoint devices using management messages along with the subnet address ranges from the endpoint devices routing table. The management serve may also be enabled to update the endpoint device list, security groups, and the pool of address ranges status. This invention may also be used to enables the use of any number of certificates to establish any number of secure tunnels with each endpoint device.

4000 Secure Network Sharing

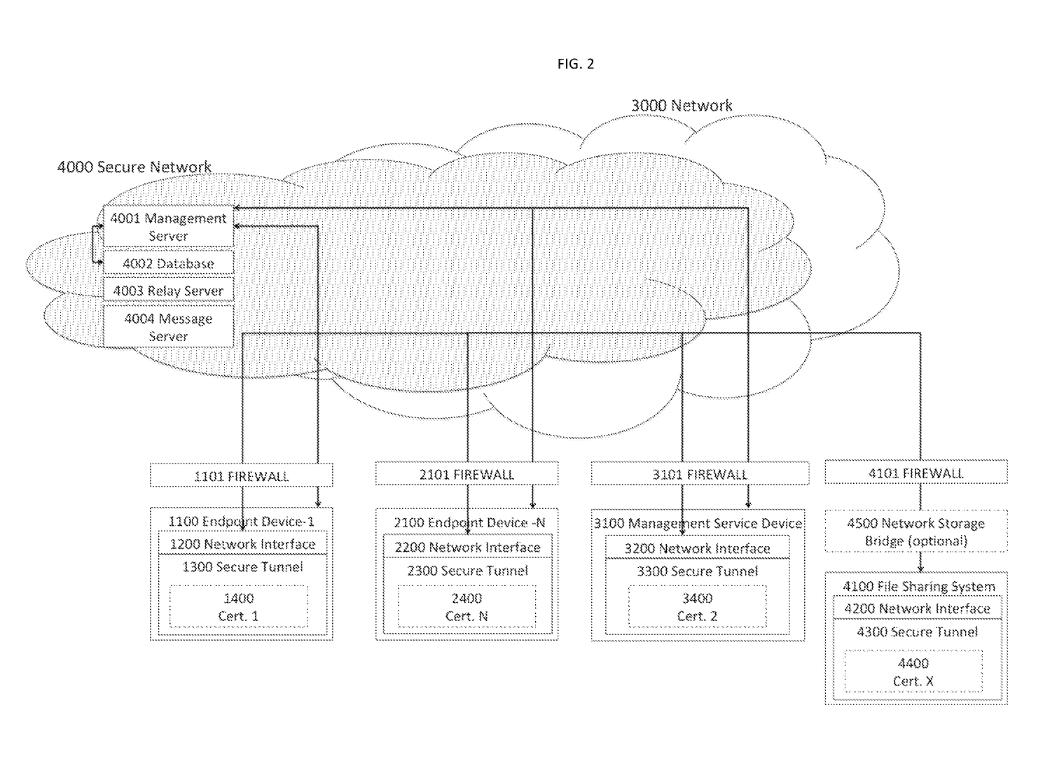

Referring to FIG. 2, a 1100 first endpoint device may securely store and share data to the 2100 second endpoint device via the establishment of a 4100 file-sharing system, either via a public cloud (e.g. using a cloud service provider) or a private cloud (e.g. using an enterprise network). An optional 4500 network storage bridge can be established as a means of establishing a secure connection between the endpoint devices via the 4000 secure network (e.g. using the steps described herein) and controlling access to the 4100 file-sharing system. To set up a 4000 secure network share with the endpoint devices within a secure contact group, including the 4500 network storage bridge if provided, the 1100 first endpoint device may create the initial version of a 512-bit network share key (“NSK”). The 1100 first endpoint device may encrypt the NSK for each peer endpoint device and the 4500 network storage bridge by wrapping the NSK, which involves creating a key (using ECDH and the endpoint's public key) and then using the key to seed AES-256 in CBC mode. The 1100 first endpoint device may then send each wrapped NSK to the appropriate peer endpoint device and the 4100 file-sharing system via secure messaging. The 1100 first endpoint device may send the NSK to the 4100 file-sharing system via the secure session established via the 4500 network storage bridge. When an additional endpoint device is added as a member to (or removed as a member from) a secure contact group, another version of the NSK maybe created and distributed to the group.

The 1100 first endpoint device may be configured to create and encrypt a single listing file, which acts as a master directory for the 4100 file-sharing system. The single file listing may contain plaintext and ciphertext file names, file sizes, file creation dates, file authors, and file types. Alternatively the 1100 first endpoint device may encrypt each plaintext file name and use the ciphertext result as the visible file name; and create and encrypt a single metadata file, which contains only file association information for each file. For example, the file association information for each file may include associating an image file with a corresponding thumbnail file.

The 1100 first endpoint device may write a file to the 4100 file-sharing system. To write a file to the 4100 file-sharing system the 1100 first endpoint device may use the NSK to encrypt the file via AES-256. For example the file may be encrypted in either XTS or CBC mode. For purposes of providing non-repudiation, the 1100 first endpoint device may also embed a signature into the file. For example the 1100 first endpoint device may use the Elliptic Curve Digital Signature Algorithm (“ECDSA”) signature processing over plaintext blocks. The 1100 first endpoint device may then send a secure message to all peer endpoint devices indicating that a new file has been written to the 4100 file-sharing system. If a listing file is used, the 1100 first endpoint device may decrypt (e.g. using the NSK), update, and re-encrypt the listing file, and then write the listing file to the 4100 file-sharing system. When receiving a secure message from a peer endpoint device, the 1100 first endpoint device may connect to the location of the new or edited file, download the file, and decrypt the file using AES-256 (e.g. in either XTS or CBC mode).

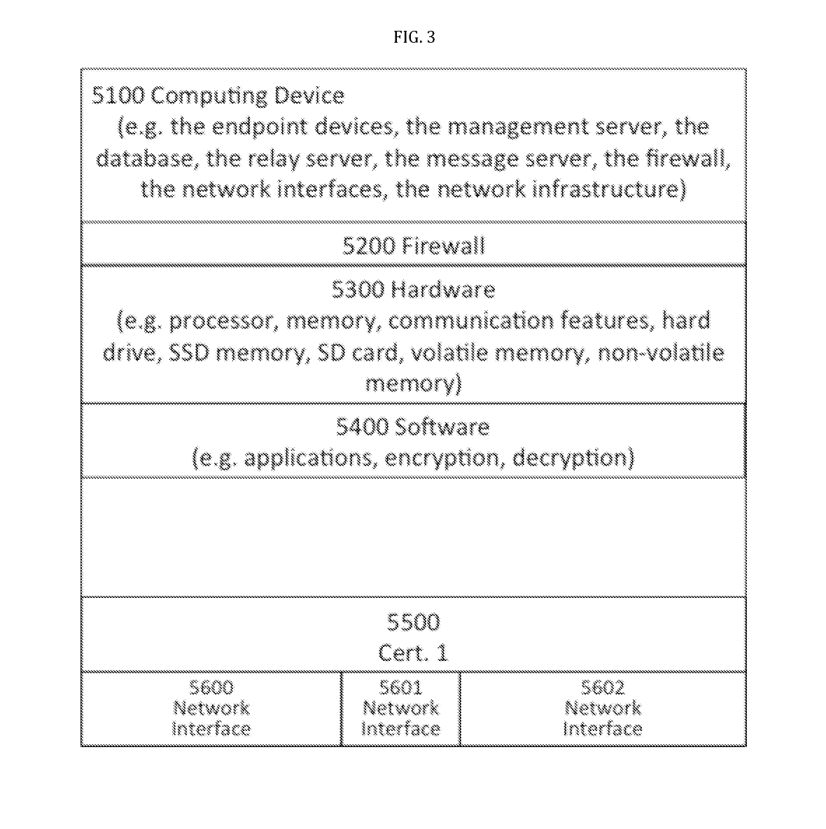

Referring to FIG. 3, the computing devices (e.g. the endpoint devices, the 4001 management server, the 4002 database, the 4003 relay server, the 4004 message server, the firewall, the network interfaces, the network infrastructure, and other components of the invention) may include internal hardware such as a processor, memory, and communication features. The computing devices may include software applications enabled to encrypt and decrypt data before sending the data through the network. The data encryption may be accomplished using any data encryption method such as Advanced Encryption Standard (“AES”). The computing devices may include smart phones, tablet PC's, notebook PC's, desktop PC's, remote monitoring devices, cameras, or sensors. The computing devices may be used for any type of communication, computing, or electronic operation. Furthermore, the computing device may comprise a physical storage device such as a hard drive, series of hard drives, SSD memory, SD Card, or any other type of local volatile or non-volatile memory. The invention is also applicable to both mobile and fixed computing devices since either type are commonly used to transmit data to and from other mobile and fixed computing devices via a communication network. Throughout this description the endpoint devices, the 4001 management server, the 4002 database, the 4003 relay server, the 4004 message server, the firewall, the network interfaces, the network infrastructure, and other components of the invention, however software components can also be used to perform the actions of any of such devices. Furthermore, the cryptographic components enabled to perform encryption and decryption may rely on asymmetric cryptography. For example, AES-GCM encryption has been described, but other methods may be used such as ECDH for key agreements, use of shared secrets, hard coded passwords, and one-time pads.

Throughout this description, references were made to devices coupled together. Such coupling includes a manner that allows the exchange and interaction of data, such that the operations and processes described may be carried out. For example, the devices may be coupled with electrical circuitry, or through wireless networks that allow the devices to transfer data, receive power, execute the operations described, and provide structural integrity. Reference was also made to interactions amongst devices via a network, however the invention is scalable to be enabled with any number of devices, servers, and/or computers than described in the specification. For example, any number of devices, networks, and servers, and/or computers may be utilized to enable this invention.

The data transmitted via this invention may include instantly transmitted data, for example in a voice or video conference call, or a delayed transmission, for example such as email or instant messaging, or stored on shared data for long-term repeated access, for example a network hard drive and/or a server for secure file sharing. The network may be either a wired or wireless communication network. The network may include a public or private network such as the internet, intranet, telecommunications system, secure messaging service, or other network capable of transmitting electronic data.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

The hereinafter expressed claims are hereby expressly incorporated into this Detailed

Specification, with each claim standing on its own as a separate embodiment of the invention. Furthermore, while some embodiments described herein include some but not other features included in other embodiments, combinations of features of different embodiments are meant to be within the scope of the invention, and form different embodiments, as would be understood by those skilled in the art.

What is claimed:

1. A system for securely transmitting data between a first endpoint device and a second endpoint device comprising:
the first endpoint device coupled to a secure network;
the second endpoint device coupled to the secure network;
the secure network enabled to establish a secure communication tunnel directly between the first endpoint device and the second endpoint device enabling the first endpoint device to transmit data directly to the second endpoint device via the secure communication tunnel; and
wherein the secure network includes a continuum server; a management server; a database; a relay server; and a message server.

2. The system of claim 1 wherein the continuum server is enabled to: manage the authentication of the first endpoint device and the second endpoint device; coordinate a capability of communication of messages between the first endpoint device and the second endpoint device and with the management server; and establish a capability of streaming data sessions between first endpoint device and the second endpoint device.

3. The system of claim 1 wherein the management server adds the first endpoint device to an endpoint device list wherein the endpoint device list includes an identity of the first endpoint device, a first certificate assigned to the first endpoint device, and a name for the first endpoint device.

4. The system of claim 1 wherein the management server adds the second endpoint device to the endpoint device list wherein the endpoint device list includes an identity of the second endpoint device, a second certificate assigned to the second endpoint device, and a name for the second endpoint device.

5. The system of claim 1 wherein the management server assigns the first endpoint device and the second endpoint device to a first security group.

6. The system of claim 1 wherein the management server introduces the first endpoint device to the second endpoint device by providing a first signed and encrypted message containing the first endpoint device with a name and a public certificate of the second endpoint device, and a second signed and encrypted message containing the second endpoint device with a name and a public certificate of the first endpoint device, along with providing both the first device and the second device the identity of a security group that both the first device and the second device are members.

7. The system of claim 1 wherein the data communicated between the first endpoint device and the second endpoint device is encrypted.

8. The system of claim 1 wherein the first endpoint device is enabled to decrypt any encrypted data sent by the second endpoint device using the certificate of the second endpoint device.

9. The system of claim 1 wherein the database is enabled to store a public certificate of the first endpoint device and the second endpoint device so that the secure network can access the public certificates of the first endpoint device and the second endpoint device to authenticate each endpoint device for secure communication directly between the first endpoint device and the second endpoint device.

10. The system of claim 1 wherein the packet relay server is enabled to act as a rendezvous point for streaming data sessions between the first endpoint device and the second endpoint device.

11. A method comprising:
coupling a first endpoint device to a secure network;
coupling a second endpoint device to the secure network;
the secure network comprising at least one continuum server; at least one management server further comprising a certificate manager and a deployment manager; at least one database; at least one relay server; and at least one message server; and
establishing a secure communication tunnel by the secure network directly between the first endpoint device and the second endpoint device enabling the first endpoint device to transmit data directly to the second endpoint device via the secure communication tunnel.

12. The method of claim 11 wherein the certificate manager executes the following management functions: certificate life cycle, secure group life cycle, and provisioning token life cycle.

13. The method of claim 11 wherein the deployment manager adds and removes certificates, keeps track of billing per use or access to the secure network, knowing the physical entity behind the certificate if applicable to an application or use scenario, identity proxies for mapping the certificate to another credential.

14. The method of claim 11 wherein the certificate manager and deployment manager are deployed using the secure network enabling each endpoint device to have an isolated root of trust from other certificate managers and other deployment managers.

15. The method of claim 11 wherein the certificate manager and deployment manager are set up as endpoint devices to the secure network.

16. The method of claim 11 wherein the management server performs at least one of the following: organizing the first endpoint device and second endpoint device into an endpoint device list; setting up a security group including the first endpoint device and the second endpoint device; securely introducing the first endpoint device assigned to the security group to the second endpoint device assigned to the security group by providing the first endpoint device with a public certificate of the second endpoint device and second endpoint device with the public certificate of the first endpoint device; securely removing the first endpoint device from the security group including removing the public certificate for the second endpoint device from the first endpoint device.

17. A method for establishing a trust proxy comprising:
a secure network acting as a proof-of-possession certificate challenge for a first endpoint device and a second endpoint device connected to the secure network via a secure communication tunnel before allowing the first endpoint device to connect to the second endpoint device;
transferring by the secure network an authenticated identity between the first endpoint device and the second endpoint device enabling the first endpoint device and the second endpoint device to know the identity of the other endpoint devices; and
authenticating by the secure network a set of data traffic from the first endpoint device before delivering the set of data traffic to the second endpoint device, wherein the secure network authenticates and delivers the set of data traffic without breaking an end-to-end confidentiality between the first endpoint device and the second endpoint device.

18. The method of 17 wherein the secure network authenticates each the first endpoint device and the second endpoint device to sit behind an inbound-blocked firewall such that the first endpoint device and the second endpoint device are not directly accessible through a network.

19. The method of 17 wherein an IP address of the first endpoint device of the secure network is changed and the secure communication tunnel through the secure network migrates to a new IP address such that any data traffic to or from the first IP address is still sent between the first endpoint device and the second endpoint device.

20. The method of 17 wherein a first IP address of the secure network is changed, and the secure communication tunnel through the secure network transitions automatically to a new first IP address such that the first endpoint device and second endpoint device connected to the first IP address are still connected at the new IP address, with no data loss between the first endpoint device and second endpoint device.
